(19) United States
(12) Patent Application Publication
(10) Pub. No.: US 2007/0001737 A1
(43) Pub. Date: Jan. 4, 2007

(54) System and method of generating a clock cycle having an asymmetric duty cycle

(75) Inventor: Raj Sundararaman, Mission Viejo, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/238,779

(22) Filed: Sep. 29, 2005

Related U.S. Application Data
(60) Provisional application No. 60/696,131, filed on Jul. 1, 2005.

(51) Int. Cl. G06F 1/04

(52) U.S. Cl. 327/291

(57) ABSTRACT

A system and method are provided for producing two asymmetric duty cycle clock phases as outputs, where the duration of the active phase may be varied to generate clock signal having an asymmetric duty cycle. A circuit configured according to the invention includes a monostable clock generator configured to produce an asymmetric duty cycle clock phase from a reference clock input, a delayed phase generator configured to produce two clock phases whose falling edges are delayed with respect to the input signals, and a second phase generator configured to produce a second asymmetric duty cycle clock phase. The phase may be programmable by including a variable resistor network that can be varied in response to control signals.

### RELATED APPLICATIONS

This application claims priority based on U.S. Provisional Application No. 60/696,131, filed on Jul. 1, 2005.

### BACKGROUND

Clock phases with asymmetric duty cycles are needed in many applications, where many processing operations are restricted to the active phase of the clock between the active edge and the following inactive edge. In such circuits, prior art systems are limited to the clock period and thus have a limited active clock phase. The timing margins for each phase to complete operations are limited, and thus restrict overall system speed. Many applications require asymmetric clock phases so that there is sufficient time for majority of the processing operations to be carried out.

Whether an input clock phase is symmetrical or asymmetrical, long duty cycles are required to properly clock a complex integrated circuit, allowing the operations of the circuit to complete their operations within the active phase of the clock. Clock phases with asymmetric duty cycles are needed in many applications where many processing operations may be restricted to the active phase of the clock between the active edge [logic HIGH] and the following inactive edge [logic LOW]. The active duty cycle may also occur during an active low clock, where the active phase of the clock could be between active edge [logic LOW] and the following inactive edge[logic HIGH]. The discussion below refers to active regions in clock cycles, which may occur during logic HIGH or logic LOW in a particular application. For example, a cascaded stage of sampled-data circuits would require long active duty cycles if the clock signal provided were symmetric. Where operational phase operations differ from each other, the result can be a slower or less efficient system. In such a circuit, each phase receives a signal from a prior stage where operations are performed, where stage 1 may receive an initial input signal and perform an operation at stage 1 at a speed according to the clock pulse received. Stage 2 may be another operation that receives the processed signal output from stage 1, and the output of stage 2 would be transmitted to the next stage after the process of stage 2 performed in time with the clock input is complete. Other stages may follow, and each would operate under a system clock that has a set duty cycle that has an active phase, a time period over which each phase operation can be started and completed, and an inactive phase where operations wait for the next active cycle phase. The inactive phase could also be something like a phase in which a reset operation is done, which requires a much smaller time than many operations in the active phase require. Hence, it would require a shorter time period than the active phase. Each stage may be part of an entire chain of sampled data circuits, for example sample-and-hold (S/H), switched-capacitor (SC) amplifier, pipelined analog-to-digital converter (ADC), or other circuits that perform signal processes. In such circuits, each phase requires time to complete its individual operation.

In conventional systems, the clock signals are generated from a master clock (or time base). For example, consider a two-phase clock system, where one phase is an inverted version of the other signal phase. In circuits having multiple phase operations, the phase has time periods where an operation is active. During these phases, when an operational phase is active, the circuit topology is periodically altered. In such circuits, it is beneficial to have an extended active phase, and are thus limited to the speed for the overall system. Many applications require asymmetric clock phases, so that there is sufficient time for majority of the processing operations to be carried out. In prior art systems, however, it is difficult to generate a useful asymmetric clock speed that allows multiple process phases to complete their individual operations.

Also, the avoidance of clock phase overlapping is important in order to ensure a certainty in the output signal. As more phases are added to a circuit, the risk of overlapping increases, as all phases operate according to the timing of a master clock. Moreover, as system speed increases, the risk of overlap further increases.

Therefore, for these reasons, there exists a need in the art for a system that generates an asymmetric duty cycle clock from a symmetric or an asymmetric input reference clock to provide enough processing time for processing at each phase to be carried out. As will be seen, the invention accomplishes this in an elegant manner

### BRIEF DESCRIPTION OF THE DRAWINGS

FIG. 1 is a diagrammatic view of a circuit configured according to the invention;

FIG. 2 is a diagrammatic view of a delayed phase generator of FIG. 1;

FIG. 3 is a diagrammatic view of a monostable clock generator of FIG. 1;

FIG. 4 is a diagrammatic view of a second phase generator of FIG. 1;

FIG. 5 is a timing diagram of simulation results with a symmetric duty cycle clock input;

FIG. 6 is a timing diagram of simulation results with a asymmetric duty cycle clock input; and

FIG. 7 is an illustration of a resistive network for use in a circuit such as FIG. 3.

### DETAILED DESCRIPTION

Many applications require asymmetric clock phases so that there is sufficient time for majority of the processing operations to be carried out. By re-allocating the available clock period judiciously between the active phase and the non active phase, overall system speed can be considerably improved. Also, as discussed in the background, the inactive phase could also be a phase in which and operation such as a reset operation is done. Such a phase requires a much smaller time than many operations in the active phase require. Hence, according to the invention, it can be made shorter compared to the active phase.

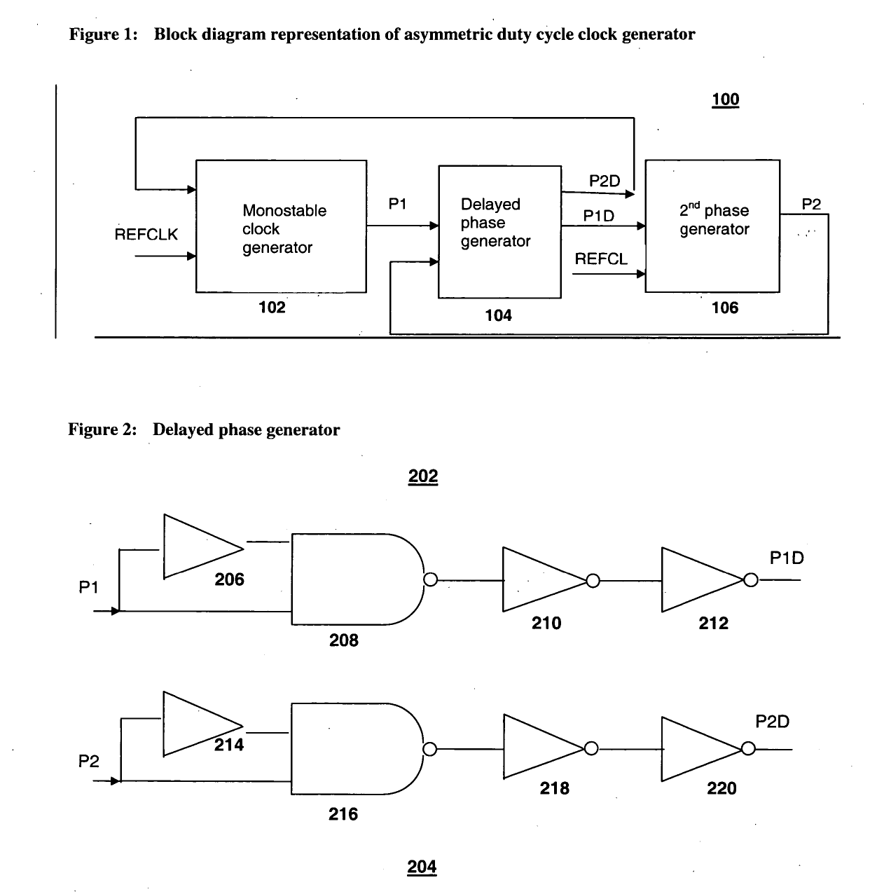

The invention is directed to a circuit that provides asymmetric clock phases as output signals by taking a reference clock, REFCLK as input. The reference clock can have a symmetric or an asymmetric duty cycle. FIG. 1 shows a block diagram representation of the clock generator 100. The circuit includes a monostable clock generator 102 configured to receive inputs P2d and REFCLK and to output signal P1. The delayed phase generator 104 is configured to receive P1 and output P2 from the second phase generator 106 and to output P2D to the monostable clock generator 102, and is further configured to output P1d to the second phase generator 106. The second phase generator is configured to receive P1D and REFCLK, and to generate P2. The feedback paths are designed such that the two clock phases, P1 and P2, are non-overlapping in the sense that they are never at logic HIGH at the same instant.

The invention provides an electronic device, an asymmetric duty cycle clock generator, wherein the active clock phases of the output signals are a greater percentage of the total clock periods generated. The device includes a monostable clock generator configured to provide an asymmetric duty cycle clock phase. The monostable clock generator includes two inputs for receiving input signals, and an out put for outputting an asymmetric duty cycle clock phase.

In one embodiment, the monostable clock generator is configured with a resistor-capacitor (R-C) circuit. The time constant of the R-C circuit controls the duty cycle of the two asymmetric clock phases. Thus, by selecting the appropriate resistor and capacitor combinations, the duty cycles can be easily adjusted.

In another embodiment, the resistor in the R-C circuit of the monostable clock generator is replaced by a resistive network of parallel resistors connected to MOSFETS. The resistive network is configured to receive control signals from external sources to switch the resistors in the circuit, thus altering the R-C time constant. Thus, in this embodiment, the device is configured to be programmable.

The device further includes a delayed phase generator configured to provide two asymmetric duty cycle clock phases whose falling edges are delayed with respect to the falling edges of the input clock phases of the device. The delayed phase generator includes two inputs for receiving the input signals, and two outputs for outputting the output signals.

Furthermore, the device includes a second phase generator configured to provide an asymmetric duty cycle clock phase. The second phase generator includes two inputs for receiving input signals, and an output for outputting an output signal. A second asymmetric duty cycle clock phase is generated to further extend the active phase of the outputs of the device thus improving timing margins and increasing the overall system speed of circuits configured to receive the output signals of the invention.

According to the invention, duty cycles of the two phases can be easily adjusted by choosing the appropriate resistor and capacitor combination. In another embodiment, the duty cycle can be programmable and thus make the active phase duration variable by having resistors in parallel and switching them in using external control signals to alter the R-C time constant which controls the duty cycle

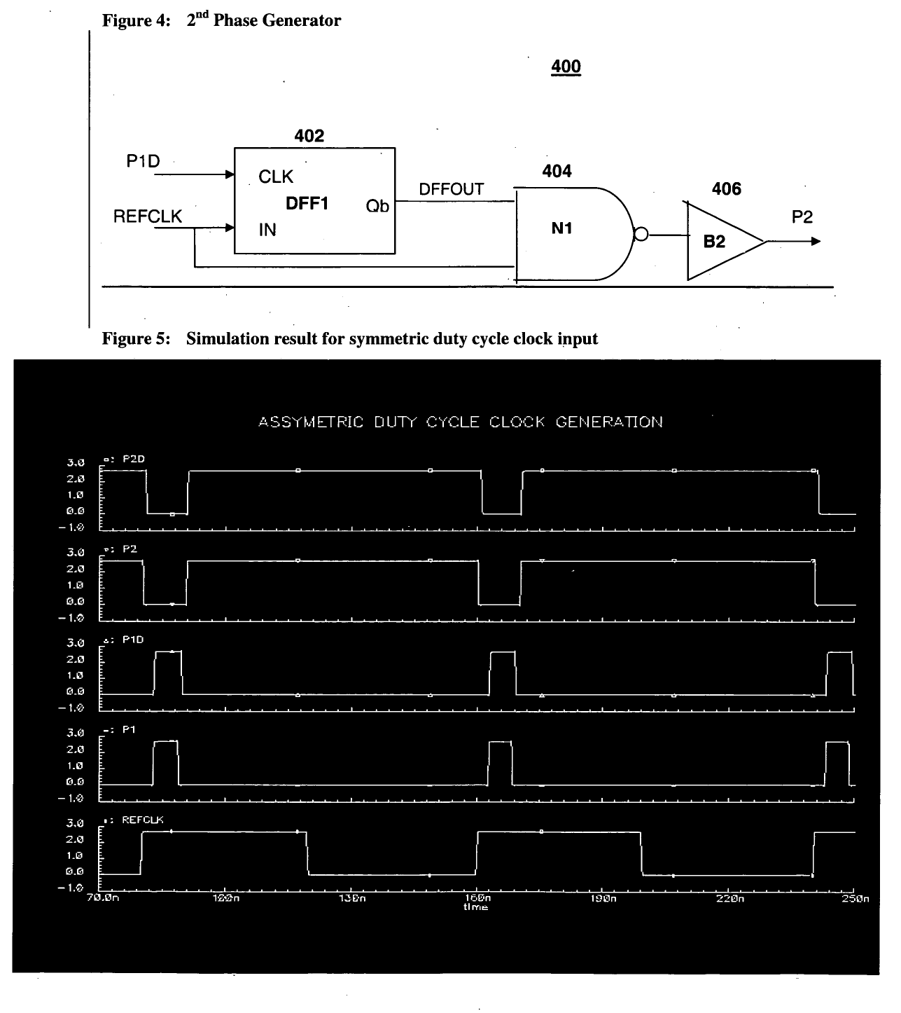

In addition, two more signals P1D and P2D, whose falling edges are delayed with respect to the falling edge of P1 and P2 respectively, are also generated through the delayed phase generators 202 and 204, as shown in FIG. 2. The first delayed phase generator 202 is configured to receive P1 as in input to a chain of two inverters making a delay element 206 and NAND gate 208, which receives the inverted signal output from the delay element 206. The output from the NAND gate 208 is inverted twice, once in inverter 210, and again in inverter 212, to produce P1D, or a delayed version of signal P1. The Second delayed phase generator 204 is configured to receive P2 as in input to a chain of two inverters making a delay element 214 and NAND gate 216, where the NAND gate also receives the inverted signal output from the delay element 214. The output from the NAND gate 216 is also inverted twice, once in inverter 218, and again in inverter 220, to produce P2D, or a delayed version of signal P2.

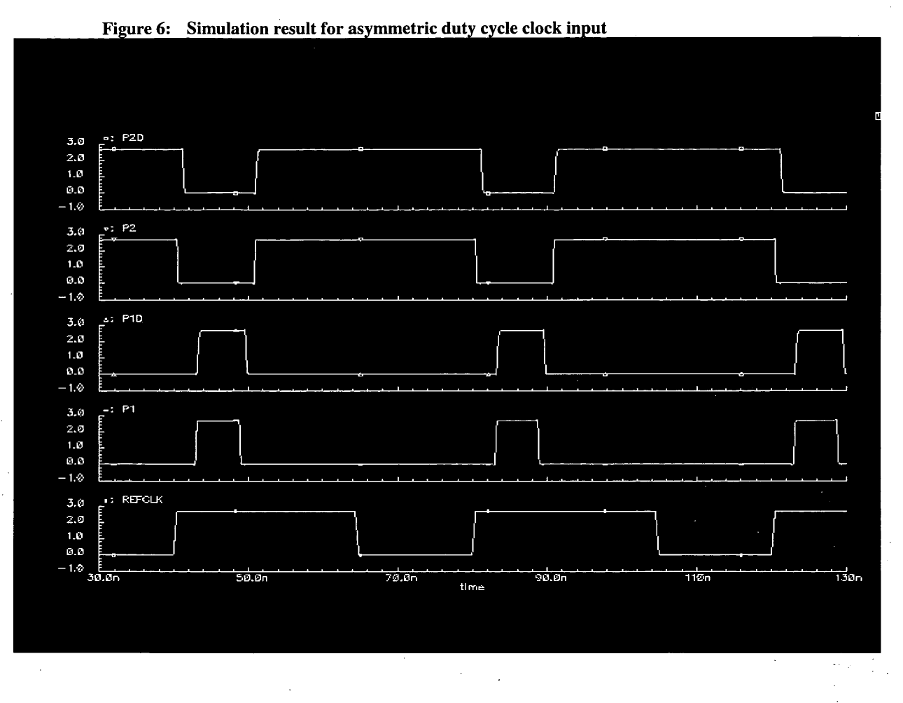

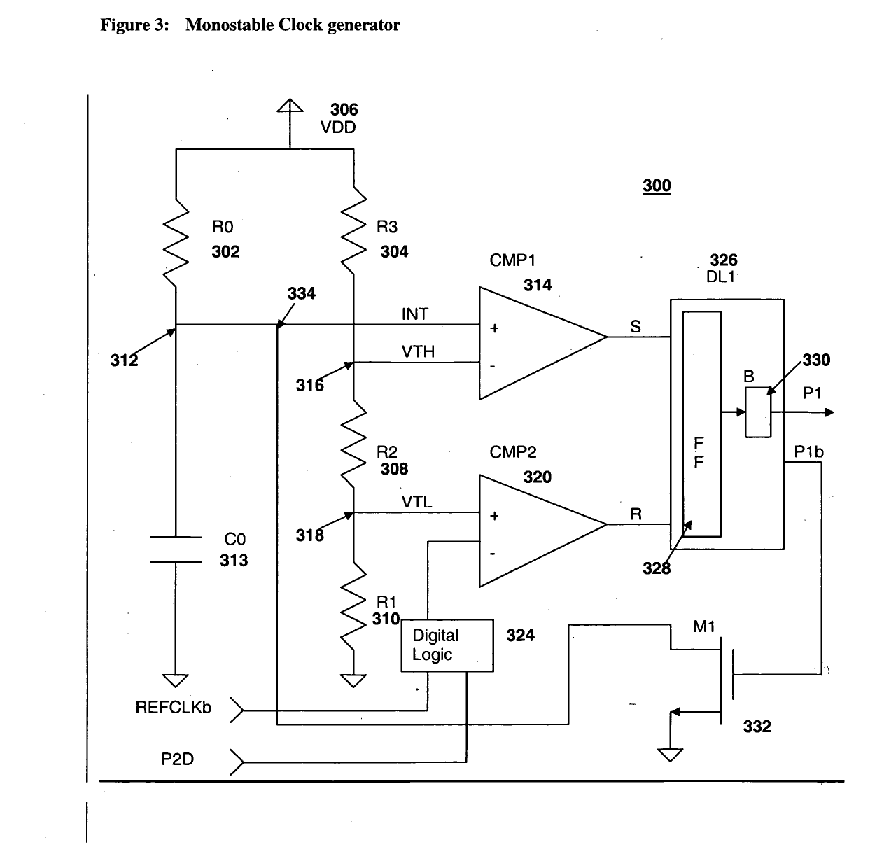

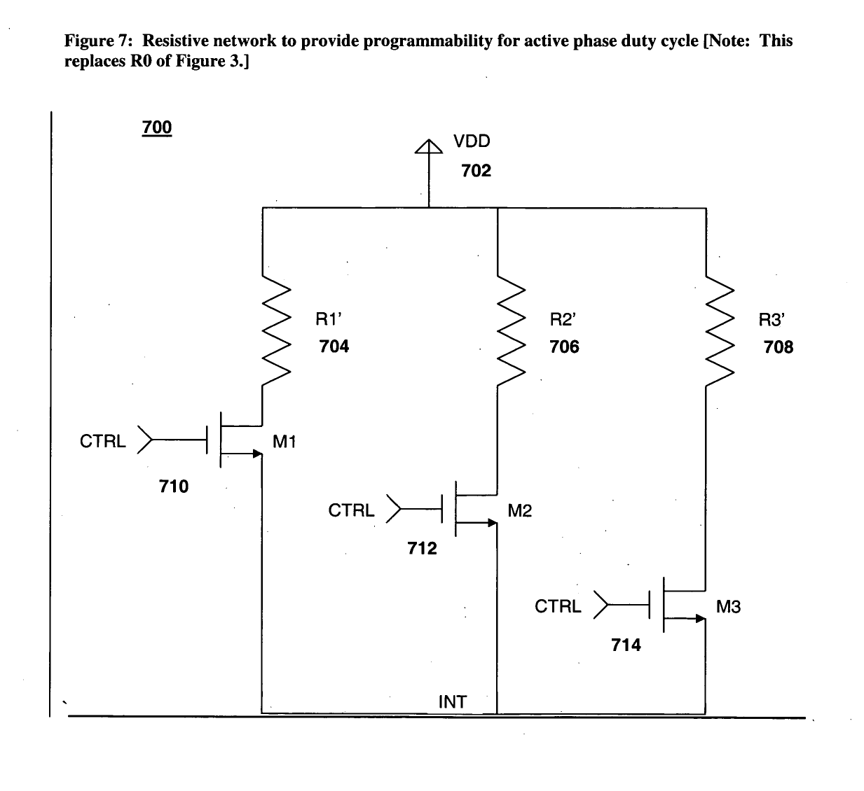

Referring to FIG. 3, a monostable clock generator includes resistors [R1] 310, [R2] 308 and [R3] 304 connected between a power supply VDD 306 and ground to form a voltage divider network. The voltage at the junction 318 of R1 and R2 is VTL={R1/(R1+R2+R3)}*VPS, where VPS is the power supply voltage. The voltage at the junction 316 of R2 and R3 is VTH={(R1+R2)/(R1+R2+R3)}*VPS. VTH is at a higher voltage level compared to VTL. The circuit also comprises of a resistor, [R0] 302 and capacitor, [C0]313 in series, the junction 312 of which is labeled INT. In operation, the voltage at INT charges up towards the value of power supply voltage VDD, with a time constant equal to the product of R0 and C0. The node INT is discharged using the output Plb through a MOSFET M1.

The voltages INT and VTH are compared using comparator, [CMP1] 314. When the value of INT is greater than VTH, the output of comparator CMP1, S is set to logic HIGH. When INT is lower than VTH, S is set LOW. [CMP2] 320 performs a similar function for the voltage levels, VTL and a combination of REFCLKb and P2D in digital logic 310 to produce the output R. The inputs REFCLKb and P2D may be combined using any logic, such as an OR gate. The reason why P2D is used here is to ensure that P1 is produced after P2d goes down and is thus non-overlapping. Comparators CMP1 and CMP2, for example, can be simple differential amplifiers with a single ended output.

Signals S and R are then input to the digital logic, [DL1] 326, which includes a flip-flop 328 and a buffer, [B1] 330. The output of DL1 produces the phase P1. The duty cycle of P1 is set by choosing appropriate values for R0 and C0 and by setting VTH and VTL to appropriate levels. P2 is then generated using REFCLK and PID as shown in FIG. 4.

Referring to FIG. 4, one embodiment of the second phase generator 400 is illustrated, having a differential unit [DFF1] 402 configured to receive inputs PID as a clock signal and REFCLK as an input signal. The output DFFOUT is generated at the Qb output, and is received by NAND gate [N1] 404 along with DFFOUT. Buffer [B2] 406 receives the output from NAND gate N1 to generate P2.

In operation, at the start of a new clock cycle, signals S and R are at logic LOW. Node INT is at Logic LOW as it has just been discharged. As REFCLK rises HIGH, its inverted signal, REFCLKb starts dropping to logic LOW. When the value goes below VTL, R goes HIGH. This resets the flip-flop, FF, making its Qb output transition to logic HIGH. This result is then buffered through B1. B1 includes of a set of two inverters to produce phase P1. Thus, P1 in effect follows Qb and transitions to logic HIGH. In the mean time, the node INT has started charging up towards VPS. As soon as it is greater than VTH, CMP1 yields logic HIGH at S, which now sets the flip-flop thus bringing Qb to logic LOW. P1 follows Qb and transitions to logic LOW. Thus the time period for which P1 stays HIGH is determined by the time taken for the node INT to go higher than VTH. This in turn is determined by the value chosen for R0 and C0. If P1 is the non-active phase, R0 and C0 are chosen so that its product is small enough compared to the REFCLK time period. Thus the non-active phase would constitute a small percentage of the total clock period. P1 is then sent through the delayed phase generator (FIG. 2) to generate P1D. P1D in conjunction with REFCLK is then input to a delay flip flop (DFF1) present in the second phase generator (FIG. 4). The falling edge of P1D resets this flip-flop thus making its Qb output, DFFOUT go to logic LOW. DFFOUT along with REFCLK is sent to a NAND gate, N1, followed by a buffer B2, the output of which is the phase P2.

The buffer includes two inverting logic gates. A logic LOW on the Qb output of the flip flop causes a transition to HIGH at P2 and thus the start of the second phase. The falling edge of REFCLK causes the Qb output of the flip-flop to go to logic HIGH. This in conjunction with the start of the next clock cycle resets the NAND gate thus ending phase P2 by transitioning it to logic LOW. At the same time, P1b, being at logic HIGH, discharges node INT through MOSFET, M1 332 (FIG. 3). FIG. 5 shows a typical simulation result when REFCLK has a symmetric duty cycle. FIG. 6 illustrates a simulation in which the REFCLK duty cycle is asymmetric. In both cases the duty cycle of phase P1 is controlled by the time constant of the Resistor, R0 and capacitor C0. As can be seen, the output of this circuit, which is configured according to the invention, illustrates non-overlapping clocks is by design. Referring to FIG. 1, the system generates P1 from the falling edge of P2D. Then, P1 generates P1D through the delayed phase generator. The falling edge of P1d generates P2 through the second phase generator which in turn is fed back in the delayed phase generator to produce P2D.

In addition, in another embodiment, R0 of FIG. 3 can be varied in a programmable manner, using the configuration 700 of FIG. 7. By choosing R, the system can convert a symmetric or an asymmetric clock to prevent overlapping clock cycles, thus to prevent both clocks from being logic HIGH at the same time. This programmability of duty cycle can be achieved by replacing the resistor R0 in FIG. 3 with a resistive network 700 between VDD 702 and INT and switching them on and off using MOSFETs and external control signals [CNTR]. For example, R0 can be replaced with a parallel combination of resistors, [R1′] 704, [R2′] 706 and [R3′] 708. Control signals [CTRL[1-3]] are received by transistors [M1, M2 and M3] 710, 712 and 714 respectively, when at logic HIGH turn on the respective MOSFETs M1-M3 and connect the resistors in parallel. Different control signals transmitted to each transistor can generate different resistance values. The equivalent value of the switched on resistors in conjunction with C0 sets the time constant that was explained above. According to the invention, different combinations could be chosen by making the appropriate control signals go to logic HIGH thus providing the capability of variable active phase duty cycle. The control signals may be generated by a control signal of a controller, such as a dedicated control circuit, a logic circuit that responds to changes in phase, or other well known means to generate control signals to set the resistance value in a manner to provide an optimal asymmetric duty clock signal.

The invention has been described in the context of an electronic device that produces two asymmetric duty cycle clock phases as outputs, where the circuit includes a monostable clock generator configured to produce an asymmetric duty cycle clock phase from a reference clock input, a delayed phase generator configured to produce two clock phases whose falling edges are delayed with respect to the input signals, and a second phase generator configured to produce a second asymmetric duty cycle clock phase. Those in the art will appreciate, however, that other variations of the circuit components are adaptable to different applications, and that the usefulness of the invention reaches beyond that described therein, and the scope of the invention is defined by the appended claims and their equivalents.

1. An electronic device that produces two asymmetric duty cycle clock phases as outputs comprising:
a monostable clock generator configured to produce an asymmetric duty cycle clock phase from a reference clock input,
a delayed phase generator configured to produce two clock phases whose falling edges are delayed with respect to the input signals, and
a second phase generator configured to produce a second asymmetric duty cycle clock phase.

2. An electronic device according to claim A1, wherein the input reference clock signal has a symmetric duty cycle

3. An electronic device according to claim A1, wherein the input reference clock signal has an asymmetric duty cycle

4. An electronic device according to claim A1, wherein the device can be configured to receive an asymmetric duty cycle reference clock input that has an active phase smaller than its non-active phase, and produce two asymmetric duty cycle clock phases as outputs wherein the active phases are larger than the non-active phases

5. An electronic device according to claim A1, wherein the duty cycles of the two phases can be adjusted

6. An electronic device according to claim A1, wherein the device can be configured such that the duty cycles of the two phases are adjustable in response to control signals.

7. An electronic device according to claim A1, that is configured such that the active phase duration of the two phases is variable.

8. An electronic device according to claims A1, wherein the active phases of the two asymmetric duty cycle clock phases are non-overlapping.
